(19) United States
(12) Patent Application Publication
(10) Pub. No.: US 2012/0309228 A1
(43) Pub. Date: Dec. 6, 2012

(54) CONNECTOR PROTECTION STRUCTURE AND PRODUCTION METHOD THEREFOR

(75) Inventors: Hiroaki Masuda, Yokkaichi-city (JP); Nobumasa Takihara, Yokkaichi-city (JP); Shinichi Igarashi, Yokkaichi-city (JP)

(73) Assignee: SUMITOMO WIRING SYSTEMS, LTD., Mie (JP)

(21) Appl. No.: 13/579,343

(22) PCT Filed: Oct. 18, 2010
(86) PCT No.: PCT/JP2010/068276

§ 371 Date: Aug. 16, 2012

(30) Foreign Application Priority Data
Apr. 30, 2010 (JP) 2010-104899

(51) Int. Cl. H01R 13/648

(52) U.S. Cl. 439/607.01

(57) ABSTRACT

A connector protection structure includes a connector electrically connected to an electric wire and a protector protecting the connector by surrounding the connector. The protector is formed of a protection material that includes a base material and a binder material having a melting point lower than that of the base material, and is joined in a joint portion thereof by cooling and solidifying the melted binder material. The connector is accommodated in an inner space formed in an inner surface of the protector. The binder material in the inner surface and outer surface is melted, cooled, and solidified such that the inner surface of the protector is harder than the outer surface of the protector.

### TECHNICAL FIELD

The present invention relates to a connector protection structure for a wire harness mounted in a vehicle and a method of producing the structure.

### BACKGROUND ART

A wire harness for a vehicle is conventionally known. A technology is also conventionally known to preassemble a connector for an optionally mounted electric component to the wire harness. Furthermore, a technology is also known to wrap a cushioning sheet around the outer periphery of the connector for the option in order to prevent noise from occurring due to interference between the connector and another component during vehicle running (e.g., Patent Literature 1).

### CITATION LIST

### Patent Literature

Patent Literature 1: Japanese Patent Laid-Open Publication No. 2001-240136

### SUMMARY OF INVENTION

### Technical Problem

In the technology disclosed in Patent Literature 1, however, attachment of the cushioning sheet to the connector requires work, for example, to wrap and bond the cushioning sheet around the outer periphery of the connector. This increases work man-hours in production of wire harnesses, and thus leads to an increase in the production cost of wire harnesses.

In addition, expensive urethane form is used for the cushioning sheet in the technology of Patent Literature 1. This increases the material cost, and thus also leads to an increase in the production cost of wire harnesses.

In view of the circumstances above, an object of the present invention is to provide a connector protection structure that provides good protection of a connector and a method of producing the structure.

### Solution to Problem

In order to address the circumstance, a first aspect provides a connector protection structure including a connector electrically connected to an electric wire and a protector protecting the connector by surrounding the connector, the protector being formed of a protection material that includes a base material and a binder material having a melting point lower than that of the base material, the protector being joined in a joint portion thereof by cooling and solidifying the melted binder material. The connector is accommodated in an inner space formed in an inner surface of the protector. The binder material in the inner surface and outer surface is melted, cooled, and solidified such that the inner surface of the protector is harder than the outer surface of the protector.

A second aspect provides the connector protection structure according to the first aspect, in which the protector includes a main body and a projection extending from the main body along the electric wire, and the projection is fixed to the electric wire.

A third aspect provides the connector protection structure according to first or second aspect, in which the connector is accommodated in the inner space through an opening provided on the electric wire side and a connecting surface of the connector is closed by a closure.

A fourth aspect provides a method of producing a connector protection structure that includes a connector electrically connected to an electric wire and a protector accommodating the connector in an inner space formed in an inner surface, the protector being formed of a protection material that includes a base material having a melting point at a first temperature and a binder material having a melting point at a second temperature lower than that of the base material. The method includes (a) a process of heating a first surface and a second surface of the protection material; (b) a process of molding the protector such that the first surface is provided as the inner surface and the second surface is provided as an outer surface; and (c) a process of cooling and solidifying the binder material melted in the process (a). In the process (a), the first surface is heated at a first treatment temperature which is equal to or higher than the second temperature and lower than the first temperature and the second surface is heated at a second treatment temperature which is equal to or higher than the second temperature and lower than the first temperature and is lower than the first treatment temperature.

A fifth aspect provides the method of producing the connector protection structure according to the fourth aspect, in which, in the process (b), the protection material is pressurized in a state where the protection material sandwiches an inner surface former, and thereby the inner space to accommodate the connector is formed on the inner surface side of the protector.

### Advantageous Effects of Invention

According to the connector protection structure and the method of producing the same of the first to fifth aspects, the outer surface of the protector is molded so as to be softer than the inner surface of the protector. Thus, even if the outer surface of the protector interferes with another component, the impact of the interference is absorbed by the outer surface of the protector, thus preventing noise from being generated by the interference.

In the connector protection structure and the method of producing the same of the first to fifth aspects, the inner space of the protector can be formed depending on a size of a connector to be mounted. Thus, simply accommodating the connector in the inner space sufficiently secures the connector to the protector. In other words, additional work, such as winding, can be reduced to fix the protector to the connector, and thus work man-hours can be reduced in production of the protection structure. This curtails the production cost of the protection structure of the connector.

In particular, according to the connector protection structure of the second aspect, the projection of the protector is fixed to the electric wire, and thus the protector is readily fixed to the electric wire. Accordingly, the protector is furthermore prevented from disengaging from the connector.

In particular, according to the connector protection structure of the third aspect, the protector provides a good coverage of the connecting surface of the connector. This effectively prevents dust and others from being deposited on the connecting surface of the connector.

In particular, according to the method of producing the connector protection structure of the fifth aspect, selecting various inner surface formers allows inner spaces corresponding to sizes of connectors to be formed in protectors. Thus, protectors that correspond to various connectors can be formed without an increase in the production cost of entire wire harnesses.

### BRIEF DESCRIPTION OF DRAWINGS

FIG. 1 is a plan view illustrating an exemplary configuration of a wire harness according to first to third embodiments of the present invention.

FIG. 2 is a front perspective view illustrating an exemplary configuration of a connector protection structure according to the first and third embodiments.

FIG. 3 is a side view illustrating the exemplary configuration of the connector protection structure according to the first and third embodiments.

FIG. 4 is a side perspective view illustrating an exemplary configuration of a heating device according to the first and second embodiments.

FIG. 5 is a front perspective view illustrating an exemplary configuration of a mold used for molding a protector according to the first and second embodiments.

FIG. 6 is a side view illustrating an exemplary method of forming the protector according to the first and second embodiments.

FIG. 7 is a rear view illustrating the exemplary method of forming the protector according to the first and second embodiments.

[Fig. 8] FIG. 8 is a side cross-sectional view illustrating an exemplary method of forming the protector according to the first to third embodiments.

FIG. 9 is a front perspective view illustrating an exemplary configuration of a connector protection structure according to the second embodiment.

FIG. 10 is a side view illustrating the exemplary configuration of the connector protection structure according to the second embodiment.

FIG. 11 is a side cross-sectional view illustrating an exemplary method of forming a protector according to the second embodiment.

FIG. 12 is a side cross-sectional view illustrating an exemplary configuration of a mold and the exemplary method of forming the protector according to the second embodiment.

### DESCRIPTION OF EMBODIMENTS

Embodiments of the present invention are described below in detail with reference to the drawings.

### 1. First Embodiment

### 1.1. Configuration of Wire Harness

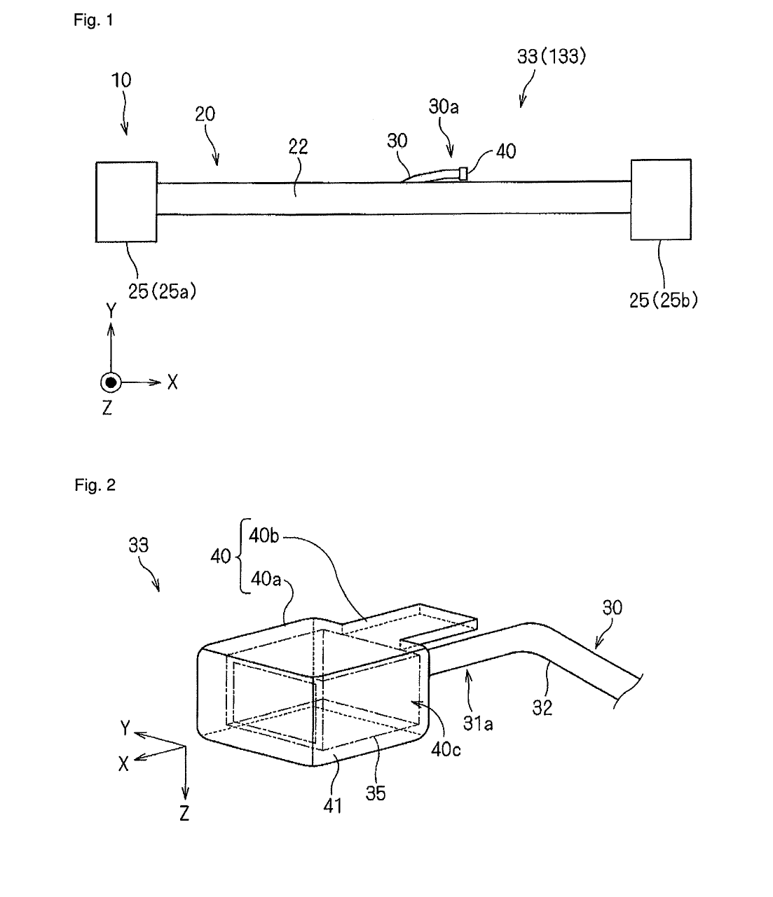

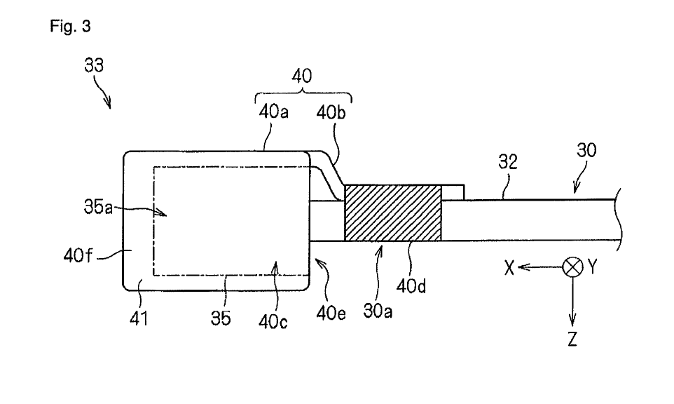

FIG. 1 is a plan view illustrating an exemplary configuration of a wire harness 10 according to first to third embodiments of the present invention. FIGS. 2 and 3 are a front perspective view and a side view, respectively, each illustrating an exemplary configuration of a connector protection structure 33.

The wire harness 10, which is a bundle of a plurality of electric wires 22 (refer to FIG. 1) and a plurality of electric wires 32 (FIGS. 2 and 3), is used for power supply and transmission and reception of signals. With reference to FIG. 1, the wire harness 10 mainly includes a main wire 20, a branch wire 30, and a protection structure 33. In order to clarify a directional relationship of these components, FIG. 1 and the drawings thereafter include, as required, an XYZ rectangular coordinate system in which a Z-axis direction is a perpendicular direction and an XY plane is a horizontal plane.

The main wire 20 includes the plurality of electric wires 22 and electrically connects connectors 25 (25a and 25b) attached to both ends. The connectors 25 (25a and 25b) at the both ends are then connected to associated connectors of electric components (not shown in the drawing).

The branch wire 30 includes, as shown in FIG. 1, at least one electric wire 32 branching from the main wire 20 and, as shown in FIGS. 2 and 3, is inserted to a connector 35 attached to one end 30a.

The protection structure 33 prevents interference between the connector 35 and another component. With reference to FIGS. 2 and 3, the protection structure 33 mainly includes the connector 35 and a protector 40.

The connector 35 is electrically connected to the plurality of electric wires 32 included in the branch wire 30, as shown in FIGS. 2 and 3. The connector 35 is connected, for example, to an optionally mounted electric component (not shown in the drawings). With no electric component in use, the connector 35 is then disposed proximate to the main wire 20 without being connected to another connector (not shown in the drawings).

The protector 40 protects the connector 35 which is unused and not connected to any electric component (not shown in the drawings). The protector 40 will be described in detail later.

### 1.2. Configuration of Protector

The protector 40 is a shock absorber formed of nonwoven fabric 41, for example. With reference to FIGS. 2 and 3, the protector 40 surrounds the connector 35 to protect the connector 35 which is unused and not connected to any electric component (not shown in the drawings). The protector 40 mainly includes a main body 40a and a projection 40b, as shown in FIGS. 2 and 3.

The nonwoven fabric 41 (protection material) is mainly composed of PET (polyethylene terephthalate: base material) and a binder material formed of a copolymer of PET and PEI (polyethylene isophthalate). More specifically, the nonwoven fabric 41 is composed of elementary fibers formed of the base material and shaped into a line and binder fibers formed of the sheath-shaped binder material disposed around the elementary fibers.

A melting point of the binder material (second temperature) is 110 to 150° C. and is defined so as to be lower than that of the base material (a melting point of PET: approximately 250° C. (first temperature)).

The main body 40a is a tubular body formed by heating and pressurizing the nonwoven fabric 41. With reference to FIGS. 2 and 3, the main body 40a has a rectangular parallelepiped or cubic shape having rounded corners.

The main body 40a has an inner space 40c therein, as shown in FIGS. 2 and 3. The connector 35 is accommodated in the inner space 40c through an opening 40e provided on the electric wire 32 side. A connecting surface (surface opposite to the surface to which the electric wires 32 are connected) 35a (refer to FIG. 3) of the connector 35 is closed by a closure 40f.

Thus, the protector 40 provides a good coverage of the connecting surface 35a of the connector 35. This effectively prevents dust and others from being deposited on the connecting surface 35a of the connector 35.

The projection 40b is a fixed piece in the main body 40a. With reference to FIGS. 2 and 3, the projection 40b projects from the main body 40a and extends along the plurality of electric wires 32. A fixing portion 40d fixes the projection 40b with respect to the electric wires 32. A fixing method of the fixing portion 40d may be taping, for example.

As described above, the protector 40 has the projection 40b projecting from the main body 40a and is thus readily fixed to the plurality of electric wires 32. Accordingly, the protector 40 is effectively prevented from disengaging from the connector 35.

### 1.3. Method of Producing Protection Structure

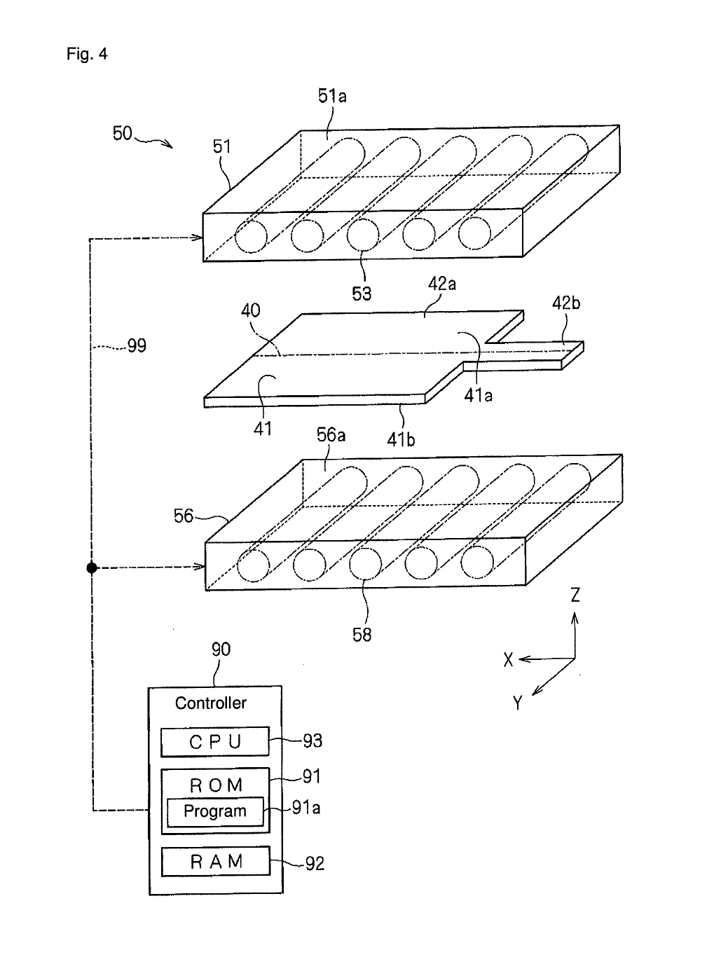

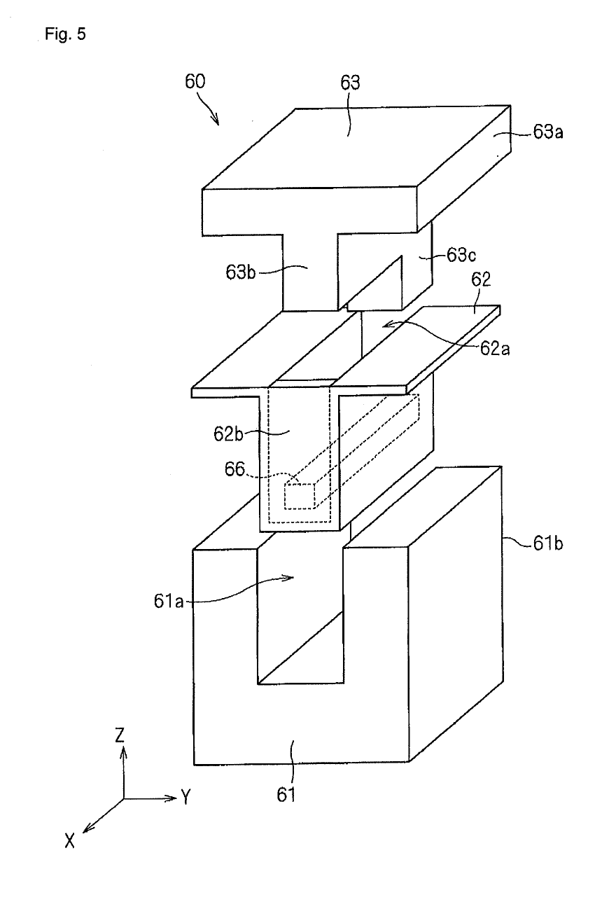

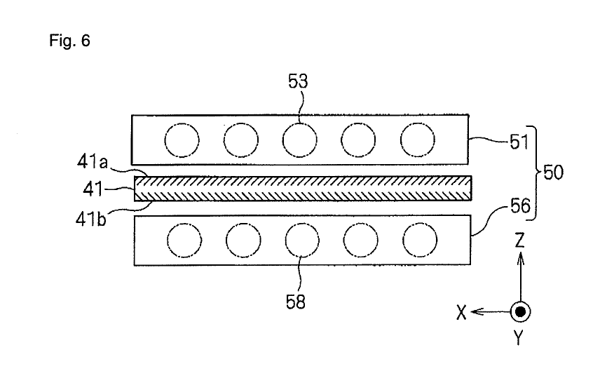

FIG. 4 is a side perspective view illustrating an exemplary configuration of a heating device 50 used in forming of the protector 40. FIG. 5 is a front perspective view illustrating an exemplary configuration of a mold 60 used for molding the protector 40. FIGS. 6 to 8 are a side view, a rear view, and a side cross-sectional view, respectively, each illustrating an exemplary method of forming the protector 40 according to the present embodiment.

Configurations of the heating device 50 and the mold 60 are described first, and then a method of producing the protection structure 33 is described.

### 1.3.1. Configuration of Heating Device

The hardware configuration of the heating device 50 is described below. The heating device 50 heats main surfaces (first and second surfaces 41a and 41b; refer to FIG. 6) of one sheet of nonwoven fabric 41 that is placed in between. With reference to FIG. 4, the heating device 50 mainly includes an inner surface heating portion 51 and an outer surface heating portion 56.

The nonwoven fabric 41 in the present embodiment has a rectangular racket shape, which mainly includes a base portion 42a and a connecting piece 42b, as shown in FIG. 4. The base portion 42a has a substantially rectangular shape (square or rectangle) in a plan view, as shown in FIG. 4, and corresponds to the main portion 40a after forming. The connecting piece 42b has a substantially rectangular shape in a plan view and extends from the base portion 42a.

The base portion 42a and the connecting piece 42b are provided adjacently, as shown in FIG. 4, such that center lines of the base portion 42a and the connecting piece 42b are aligned in one straight line in a connecting direction (X-axis direction). The straight line defined by the two center lines serves as a folding line 44 of the nonwoven fabric 41.

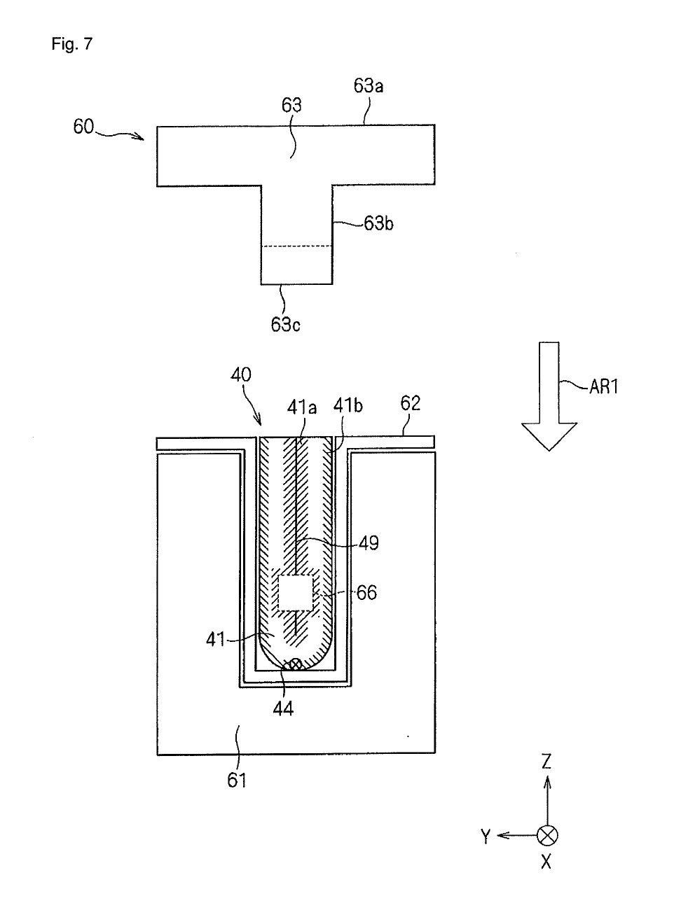

Furthermore, with reference to FIG. 7, the protector 40 of the present embodiment is formed such that the first surface 41a of the base portion 42a of the nonwoven fabric 41 is provided as an inner surface of the protector 40 and the second surface 41b of the base portion 42a of the nonwoven fabric 41 is provided as an outer surface of the protector 40.

The inner surface heating portion 51 heats the first surface 41a, which will be the inner surface of the protector 40 after forming, at a first treatment temperature that is equal to or higher than the melting point of the binder material (second temperature) and lower than the melting point of the base material (first temperature). As shown in FIG. 4, the inner surface heating portion 51 has a heater 53.

The heater 53 is a heating component embedded in a main body 51a, as shown in FIG. 4. With the heater 53 driven, the main body 51a increases its temperature and heats the first surface 41a of the nonwoven fabric 41.

The outer surface heating portion 56 heats the second surface 41b, which will be the outer surface of the protector 40 after forming, at a second treatment temperature that is equal to or higher than the melting point of the binder material and lower than the melting point of the base material and is lower than the first treatment temperature. As shown in FIG. 4, the outer surface heating portion 56 has a heater 58.

The heater 58 is a heating component embedded in a main body 56a, as shown in FIG. 4. With the heater 58 driven, the main body 56a increases its temperature and heats the second surface 41b of the nonwoven fabric 41.

A controller 90 performs, for example, control of heating by the heaters 53 and 58 and data calculation. As shown in FIG. 4, the controller 90 mainly includes a ROM 91, a RAM 92, and a CPU 93. The controller 90 is electrically connected to the components of the heating device 50 (e.g., heaters 53 and 58) through signal lines 99, as shown in FIG. 4.

The ROM (Read Only Memory) 91 is a so-called nonvolatile memory and stores a program 91a, for example. The ROM 91 may be a flash memory, which is a readable and writable nonvolatile memory.

The RAM (Random Access Memory) 92 is a volatile memory and stores data used in calculation by the CPU 93, for example. The CPU (Central Processing Unit) 93 executes control based on the program 91a of the ROM 91 (e.g., control of heating to the nonwoven fabric 41) and data calculation.

### 1.3.2. Configuration of Mold

The hardware configuration of the mold 60 is described below. The mold 60 pressurizes the nonwoven fabric 41 heated by the heating device 50 so as to mold the nonwoven fabric 41 into the protector 40 having a desired shape. With reference to FIG. 5, the mold 60 mainly includes a holder 61, a support plate 62, a compressor 63, and an inner surface former 66.

The holder 61 is a holding component having a substantially U shape in a front view, as shown in FIG. 5, and supports the support plate 62. A holding space 61a is a space defined by side walls 61b of the holder 61.

The support plate 62 is supported by the holder 61 in a state of being fitted in the holding space 61a. As shown in FIG. 5, a partition plate 62b is provided to partition a placement space 62a in the front (plus X-axis side) of the support plate 62.

With reference to FIG. 7, the support plate 62 accommodates the nonwoven fabric 41 to be pressurized. The nonwoven fabric 41 is folded along the folding line 44 (refer to FIG. 7), for example, and is then inserted into the placement space 62a and accommodated in the support plate 62.

The compressor 63 is a pressurizing component that applies pressure to the nonwoven fabric 41 inserted in the placement space 62a. The compressor 63 mainly includes a flat portion 63a, an insertion portion 63b, and a projecting portion 63c, as shown in FIG. 5.

Each of the flat portion 63a, the insertion portion 63b, and the projecting portion 63c is a substantially rectangular parallelepiped block. As shown in FIG. 5, the projecting portion 63c is provided to the insertion portion 63b so as to have a substantially L shape in a side view in combination with the insertion portion 63b. As shown in FIG. 5, the insertion portion 63b is provided to the flat portion 63a so as to have a substantially T shape in a front view in combination with the flat portion 63a. Furthermore, the insertion portion 63b and the projecting portion 63c can be inserted into the placement space 62a of the support plate 62. Thus, inserting the insertion portion 63b and the projecting portion 63c into the placement space 62a pressurizes the nonwoven fabric 41 held by the support plate 62 (refer to FIG. 8).

The first surface 41a of the nonwoven fabric 41 is heated at the first treatment temperature which is higher than the heating temperature (second treatment temperature) of the second surface 41b of the nonwoven fabric 41. Specifically, operation of the heaters 53 and 58 is controlled such that meltage of the binder material in the first surface 41a is greater than meltage of the binder material in the second surface 41b. Thus, the inner surface (corresponding to the first surface 41a) of the protector 40 molded by the mold 60 is harder than the outer surface (corresponding to the second surface 41b) thereof.

The nonwoven fabric 41 can be inserted into the placement space 62a with the partition plate 62b of the support plate 62 as a reference surface. In addition, the insertion portion 63b can be inserted into the placement space 62a as being guided by the partition plate 62a. Thus, the compressor 63 can be positioned properly relative to the nonwoven fabric 41.

The inner surface former 66 is a bar-shaped body used for forming the inner space 40c in the protector 40. The inner surface former 66 is inserted between the nonwoven fabric 41 folded along the folding line 44 so as to face the first surface 41a of the nonwoven fabric 41. This forms a space to accommodate the connector 35 in the pressurized protector 40.

### 1.3.3. Method of Producing Protection Structure Using Heating Device and Mold

A method of producing the protection structure 33 is described below with reference to FIGS. 6 to 8. In the method of producing the protection structure 33, the heaters 53 and 58 are driven by the controller 90, and then the first and second surfaces 41a and 41b of the nonwoven fabric 41 are heated at the first and second treatment temperatures, respectively (refer to FIG. 6). Thus, a portion or all of the binder material in first and second surfaces 41a and 41b of the nonwoven fabric 41 is melted and spread into the base material.

Subsequently, the nonwoven fabric 41 is valley-folded along the folding line 44 such that the first surface 41a is provided inside and the outer surface 41b is provided outside. Thus, the first surface 41a serves as the inner surface of the protector 40 and the outer surface 41 b serves as the outer surface of the protector 40.

Subsequently, the folded nonwoven fabric 41 is inserted into the placement space 62a of the support plate 62. Then, the inner surface former 66 is inserted between the folded nonwoven fabric 41 so as to face the first surface 41a of the nonwoven fabric 41 (refer to FIG. 7). Thus, the pre-heated protector 40 is provided. In this case, the inner surface former 66 is disposed at a desired distance D1 from the partition plate 62b (refer to FIG. 8).

Subsequently, with the bar-shaped inner surface former 66 inserted between the nonwoven fabric 41, the nonwoven fabric 41 is pressurized in a direction of an arrow ARI (compressing direction; refer to FIG. 7). Then, the base portion 42a of the nonwoven fabric 41 is compressed by the insertion portion 63b of the compressor 63, and thus the inner space 40c to accommodate the connector 35 is formed on the first surface 41a (inner surface) side of the protector 40 (refer to FIG. 8). Furthermore, the connecting piece 42b of the nonwoven fabric 41 is compressed by the projecting portion 63c of the compressor 63, and thus the projection 40b is formed (refer to FIG. 8).

Selecting the inner surface former 66 from various sizes (e.g., various cross-sectional sizes) allows the inner space 40c of the protector 40 to be formed to meet the size of the connector 35. Thus, protectors 40 that correspond to various connectors can be formed without an increase in the production cost of the protection structure 33 and the wire harness 10.

Then, the nonwoven fabric 41 is pressurized, and thereafter the protector 40 is cooled by air and the like, thus completing forming the protector 40. The protector 40 is joined at a joint portion 49 thereof after the melted binder material is cooled and solidified. The first and second surfaces 41a and 41b are hardened based on an amount of pressure by the compressor 63 and meltage of the binder material.

### 1.4. Advantages of Protection Structure of First Embodiment

As described above, in the protection structure 33 of the present embodiment, the binder material in the first and second surfaces 41a and 41b of the protector 40 is melted and then cooled and solidified such that the first surface 41a (inner surface) of the protector 40 is harder than the second surface 41b (outer surface) of the protector 40. Specifically, the second surface 41b of the protector 40 is formed so as to be softer than the first surface 41a of the protector 40. Thus, even if the second surface 41b of the protector 40 interferes with another component, the impact of the interference is absorbed by the protector 40, thus preventing noise from being generated by the interference.

Furthermore, in the protection structure 33 of the present embodiment, the inner space 40c of the protector 40 can be formed to meet the size of the connector 35 to be mounted. Thus, simply accommodating the connector 35 in the inner space 40c sufficiently secures the connector 35 to the protector 40. In other words, additional work, such as winding, can be reduced to fix the protector 40 to the connector 35, and thus work man-hours can be reduced in production of the protection structure 33. This curtails the production cost of the protection structure 33 of the connector 35.

In addition, in the protection structure 33 of the present embodiment, the protector 40 can be formed of the inexpensive nonwoven fabric 41. This curtails the production cost of the protection structure 33 of the connector 35.

### 2. Second Embodiment

A second embodiment of the present invention is described below. The second embodiment is similar to the first embodiment except for differences in a configuration of a protector and a method of forming the same. Thus, the description below focuses on the differences.

In the description below, configuration components similar to configuration components in the first embodiment are denoted with the same reference numerals. Since the configuration components with the same reference numerals are already described in the first embodiment, descriptions thereof are omitted in the present embodiment.

### 2.1. Configuration of Protector

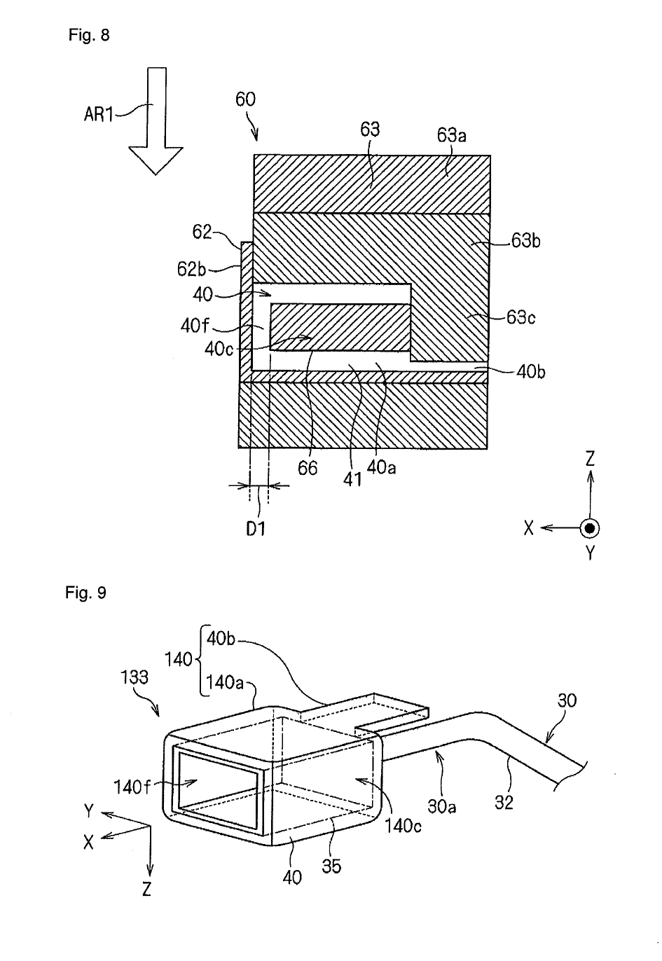

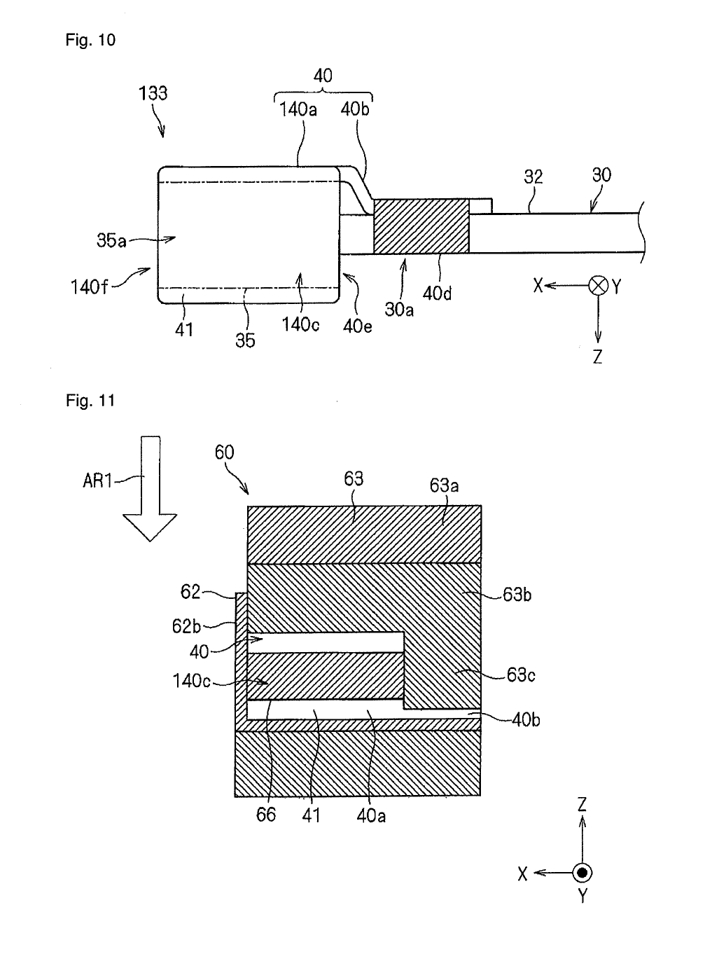

FIGS. 9 and 10 are a front perspective view and a side view, respectively, each illustrating an exemplary configuration of a connector protection structure 133. Similar to the protection structure 33 of the first embodiment, the protection structure 133 prevents interference between the connector 35 and another component. The protection structure 133 mainly includes the connector 35 and a protector 140, as shown in FIGS. 9 and 10.

Similar to the protector 40 of the first embodiment, the protector 140 is a shock absorber formed of the nonwoven fabric 41. The protector 140 mainly includes a main body 140a and the projection 40b, as shown in FIGS. 9 and 10.

The main body 140a is a tubular body formed by heating and pressurizing the nonwoven fabric 41. Similar to the main body 40a of the first embodiment, the main body 140a has a rectangular parallelepiped or cubic shape having rounded corners, as shown in FIGS. 9 and 10.

An inner space 140c is a through-hole that passes through the protector 140. As shown in FIG. 10, the connector 35 is accommodated in the inner space 140c such that the opening 40e is provided on the electric wire 32 side and an opening 140f is provided on the connecting surface 35a side.

### 2.2. Method of Producing Protection Structure

FIG. 11 is a side cross-sectional view illustrating an exemplary method of forming the protector 140 according to the present embodiment. A method of producing the protection structure 133 using the heating device 50 and the mold 60 is described below with reference to FIGS. 6, 7, and 11.

In the method of producing the protection structure 133, the heaters 53 and 58 are driven by the controller 90 similar to the case of the first embodiment, and then the first and second surfaces 41a and 41b of the nonwoven fabric 41 are heated at the first and second treatment temperatures, respectively (refer to FIG. 6). Thus, a portion or all of the binder material of the first and second surfaces 41a and 41b of the nonwoven fabric 41 is melted and spread into the base material.

Then, similar to the case of the first embodiment, the nonwoven fabric 41 is valley-folded along the folding line 44 such that the first surface 41a is provided inside and the outer surface 41b is provided outside. Thus, the first surface 41a serves as the inner surface of the protector 40 and the outer surface 41b serves as the outer surface of the protector 40.

Subsequently, the folded nonwoven fabric 41 is inserted into the placement space 62a of the support plate 62. Then, the inner surface former 66 is inserted between the folded nonwoven fabric 41 so as to face the first surface 41a of the nonwoven fabric 41 (refer to FIG. 7). Thus, the pre-heated protector 40 is provided. In this case, the front end of the inner surface former 66 is pressed against and brought into contact with the partition plate 62b (refer to FIG. 11).

Subsequently, with the bar-shaped inner surface former 66 inserted between the nonwoven fabric 41, the nonwoven fabric 41 is pressurized in the direction of the arrow AR1 (compressing direction; refer to FIG. 7). Then, the base portion 42a of the nonwoven fabric 41 is compressed by the insertion portion 63b of the compressor 63, and thus the inner space 140c to accommodate the connector 35 is formed on the first surface 41a (inner surface) side of the protector 40 (refer to FIG. 11). Furthermore, the connecting piece 42b of the nonwoven fabric 41 is compressed by the projecting portion 63c of the compressor 63, and thus the projection 40b is formed (refer to FIG. 11).

Selecting the inner surface former 66 from various sizes (e.g., various cross-sectional sizes) allows the inner space 140c of the protector 140 to be formed to meet the size of the connector 35. Thus, protectors 140 that correspond to various connectors can be formed without an increase in the production cost of the protection structure 133 and the wire harness 10.

Then, the nonwoven fabric 41 is pressurized, and thereafter the protector 140 is cooled by air and the like, thus completing forming the protector 140.

### 2.3. Advantages of Protection Structure of Second Embodiment

As described above, the protection structure 133 of the present embodiment can be formed such that the second surface 41b of the protector 140 is softer than the first surface 41a of the protector 140, similar to the case of the first embodiment. Thus, even if the second surface 41b of the protector 140 interferes with another component, the impact of the interference is absorbed by the protector 140, thus preventing noise from being generated by the interference.

Furthermore, in the protection structure 133 of the present embodiment, the inner space 140c of the protector 140 can be formed to meet the size of the connector 35 to be mounted, similar to the case of the first embodiment. Thus, simply accommodating the connector 35 in the inner space 140c sufficiently secures the connector 35 to the protector 40. This curtails the production cost of the protection structure 133 of the connector 35, similar to the case of the first embodiment.

In addition, in the protection structure 133 of the present embodiment, the protector 140 can be formed of the inexpensive nonwoven fabric 41, similar to the case of the first embodiment. This curtails the production cost of the protection structure 133 of the connector 35.

### 3. Third Embodiment

A third embodiment of the present invention is described below. The third embodiment is different in that the nonwoven fabric 41 is heated and molded by the same device (mold 260), whereas, in the first embodiment, the separate devices (heating device 50 and mold 60) are used for heating and molding.

Thus, the description below focuses on the difference. In the description below, configuration components similar to configuration components in the first embodiment are denoted with the same reference numerals. Since the configuration components with the same reference numerals are already described in the first embodiment, descriptions thereof are omitted in the present embodiment.

### 3.1. Method of Producing Protection Structure

### 3.1.1. Configuration of Mold

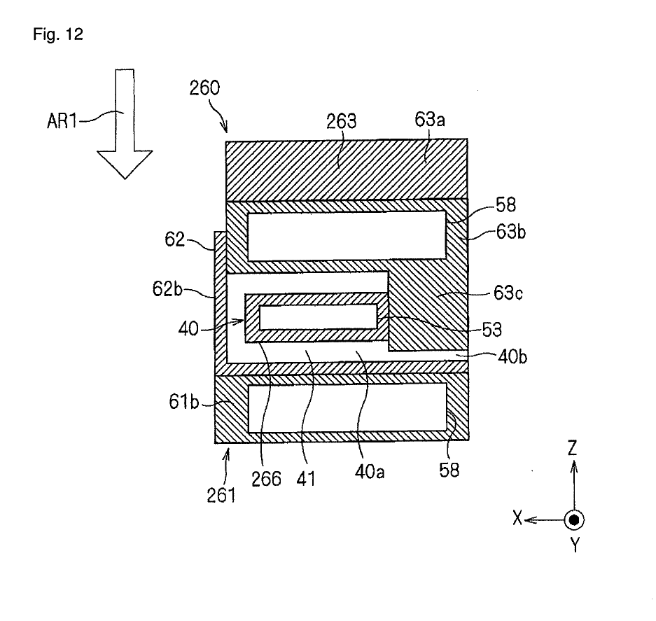

FIG. 12 is a side view illustrating an exemplary configuration of the mold 260 and an exemplary method of forming the protector 40 according to the present embodiment. The mold 260 heats and pressurizes the nonwoven fabric 41 so as to mold the nonwoven fabric 41 into the protector 40 having a desired shape. With reference to FIG. 12, the mold 260 mainly includes a holder 261, a support plate 62, a compressor 263, and an inner surface former 266.

The holder 261, which has an external shape similar to the holder 61 of the first embodiment, supports the support plate 62. As show in FIG. 12, the holder 261 has the heater 58 embedded in the side wall 61b to heat the second surface 41b of the nonwoven fabric 41.

The compressor 263, which has an external shape similar to the compressor 63 of the first embodiment, applies pressure to the nonwoven fabric 41 inserted in the placement space 62a. As show in FIG. 12, the compressor 263 has the heater 58 embedded in the insertion portion 63b to heat the second surface 41b of the nonwoven fabric 41.

The inner surface former 266, which has an external shape similar to the inner surface former 66 of the first embodiment, is used for forming the inner space 40c in the protector 40. As show in FIG. 12, the inner surface former 266 has the heater 53 embedded therein to heat the first surface 41a of the nonwoven fabric 41.

### 3.1.2. Method of Producing Protection Structure Using Mold

A method of producing the protection structure 33 is described below with reference to FIG. 12. In the production method of the present embodiment, the nonwoven fabric 41 is folded first centered on the folding line 44 such that the first surface 41a is provided inside and the outer surface 41b is provided outside. Thus, the first surface 41a serves as the inner surface of the protector 40 and the outer surface 41b serves as the outer surface of the protector 40.

Subsequently, the folded nonwoven fabric 41 is inserted into the placement space 62a of the support plate 62. Then, the inner surface former 266 is inserted between the folded nonwoven fabric 41 so as to face the first surface 41a of the nonwoven fabric 41. Thus, the pre-heated protector 40 is provided.

Subsequently, the heaters 53 and 58 are driven by the controller 90, and then the first and second surfaces 41a and 41b of the nonwoven fabric 41 are heated at the first and second treatment temperatures, respectively. Thus, a portion or all of the binder material of first and second surfaces 41a and 41b of the nonwoven fabric 41 is melted and spread into the base material.

In addition to the heat treatment, the nonwoven fabric 41 is pressurized in a direction of an arrow AR1 (refer to FIG. 12). Then, the base portion 42a of the nonwoven fabric 41 is compressed by the insertion portion 63b of the compressor 63, and thus the inner space 40c to accommodate the connector 35 is formed on the first surface 41 a (inner surface) side of the protector 40 (refer to FIG. 12). Furthermore, the connecting piece 42b of the nonwoven fabric 41 is compressed by the projecting portion 63c of the compressor 63, and thus the projection 40b is formed (refer to FIG. 12).

Then, the heating by the heaters 53 and 58 is stopped, and the protector 40 is cooled by air and the like, thus completing forming the protector 40.

Similar to the case of the first embodiment, the protector 40 is joined at the joint portion 49 thereof after the melted binder material is cooled and solidified. Similar to the case of the first embodiment, the first and second surfaces 41a and 41b are hardened based on an amount of pressure by the compressor 263 and meltage of the binder material.

### 3.2. Advantages of Protection Structure of Third Embodiment

As described, the protector 40 similar to that in the first embodiment can be formed in the present embodiment.

In addition, in the method of producing the protection structure 33 of the present embodiment, the protector 40 can be heated and molded by the same device. This reduces work man-hours required for heating and molding the protector 40, and thus curtailing the production cost of the protection structure 33 of the connector 35.

### 4. Modification

The embodiments of the present invention were described above. The present invention, however, is not limited to the embodiments above and may be modified in various ways.

In the present embodiments, the protector 40 is formed of one sheet of nonwoven fabric 41. A method of molding the protector 40 is not limited to this method. The protector 40 may be formed by heating and pressurizing two sheets of nonwoven fabric. Furthermore, the protector 40 may be formed of three or more sheets of nonwoven fabric.

### Reference Signs List

10: Wire Harness

20: Main Wire

22, 32: Electric Wire

25, 35: Connector

30: Branch Wire

33: Protection Structure

35a: Connecting Surface

40, 140: Protector

40a, 140a: Main Body

40b: Projection

40c, 140c: Inner Space

40d: Fixing Portion

40e, 140f: Opening

40f: Closure

41: Nonwoven Fabric

41a: First Surface (inner surface)

41b: Second Surface (outer surface)

44: Folding Line

49: Joint Portion

50: Heating Device

51: Inner Surface Heating Portion

53, 58: Heater

56: Outer Surface Heating Portion

60, 260: Mold

61, 261: Holder

62: Support Plate

63, 263: Compressor

66, 266: Inner Surface Former

90: Controller

1. A connector protection structure comprising:
(a) a connector electrically connected to an electric wire; and
(b) a protector protecting the connector by surrounding the connector, the protector being formed of a protection material that comprises a base material and a binder material having a melting point lower than that of the base material, and the protector being joined in at a joint portion thereof by cooling and solidifying the melted binder material, wherein
the connector is accommodated in an inner space formed in an inner surface of the protector, and
the binder material in the inner surface and outer surface is melted, cooled, and solidified such that the inner surface of the protector is harder than the outer surface of the protector.

2. The connector protection structure according to claim 1, wherein
the protector comprises:
a main body; and
a projection projecting from the main body and extending along the electric wire, and
the projection is fixed to the electric wire.

3. The connector protection structure according to claim 1, wherein
the connector is accommodated in the inner space through an opening provided on the electric wire side, and
a connecting surface of the connector is closed by a closure of the protector.

4. A method of producing a connector protection structure that comprises a connector electrically connected to an electric wire and a protector accommodating the connector in an inner space formed in an inner surface, the protector being formed of a protection material that comprises a base material having a melting point at a first temperature and a binder material having a melting point at a second temperature lower than that of the base material, the method comprising:
(a) heating a first surface and a second surface of the protection material;
(b) molding the protector such that the first surface is provided as the inner surface and the second surface is provided as an outer surface; and
(c) cooling and solidifying the binder material melted during the heating, wherein
during the heating, the first surface is heated at a first treatment temperature which is equal to or higher than the second temperature and lower than the first temperature and the second surface is heated at a second treatment temperature which is equal to or higher than the second temperature and lower than the first temperature and is lower than the first treatment temperature.

5. The method of producing the connector protection structure according to claim 4, wherein, during the molding, the protection material is pressurized in a state where the protection material sandwiches an inner surface former, and thereby the inner space to accommodate the connector is formed on the inner surface side of the protector.

6. The connector protection structure according to claim 2, wherein
the connector is accommodated in the inner space through an opening provided on the electric wire side, and
a connecting surface of the connector is closed by a closure of the protector.
